(19) United States
(12) Patent Application Publication
(10) Pub. No.: US 2024/0176578 A1
(43) Pub. Date: May 30, 2024

(54) AUDIO OUTPUT METHOD, DEVICE, AND ELECTRONIC DEVICE

(71) Applicant: Lenovo (Beijing) Limited, Beijing (CN)

(72) Inventors: Yakun YOU, Beijing (CN); Wenlong DU, Beijing (CN)

(21) Appl. No.: 18/484,529

(22) Filed: Oct. 11, 2023

(30) Foreign Application Priority Data
Nov. 30, 2022 (CN) 202211519736.0

(51) Int. Cl. G06F 3/16; G06F 3/04886

(52) U.S. Cl. CPC G06F 3/165; G06F 3/04886

(57) ABSTRACT

An audio output method includes determining a first screen where an application is located and outputting an audio of the application to a first audio output device corresponding to the first screen.

### CROSS-REFERENCE TO RELATED APPLICATION

The present disclosure claims priority to Chinese Patent Application No. 202211519736.0, filed on Nov. 30, 2022, the entire content of which is incorporated herein by reference.

### TECHNICAL FIELD

The present disclosure relates to the computer technology field and, more particularly, to an audio output method, an audio output device, and an electronic device.

### BACKGROUND

For an electronic device having a plurality of display screens, to allow a plurality of users to use different screens of the electronic device to play audios of different applications simultaneously, an audio of a specific application is generally set in the operating system to be output to a specific audio device. Thus, when one of the users wants another user to listen to the audio of the application that is currently used, the user needs to change the setting in the operating system. Accordingly, the user needs to constantly modify the settings when using the electronic device, which affects the user experience.

### SUMMARY

Embodiments of the present disclosure provide an audio output method. The method includes determining a first screen where an application is located and outputting an audio of the application to a first audio output device corresponding to the first screen.

Embodiments of the present disclosure provide an audio output device, including a determination module and an output module. The determination model is configured to determine a first screen where an application is located. The output module is configured to output an audio of the application to a first audio output device corresponding to the first screen. Embodiments of the present disclosure provide an electronic device, including a processor and a memory. The memory is communicatively connected to the processor and stores executable instructions that, when executed by the processor, cause the processor to determine a first screen where an application is located and output an audio of the application to a first audio output device corresponding to the first screen.

### BRIEF DESCRIPTION OF THE DRAWINGS

FIG. 1 illustrates a schematic flowchart of an audio output method according to some embodiments of the present disclosure.

FIG. 2 illustrates a schematic diagram showing a plurality of screens of an electronic device according to some embodiments of the present disclosure.

FIG. 3 illustrates a schematic diagram showing a plurality of screens of another electronic device according to some embodiments of the present disclosure.

FIG. 4 illustrates a schematic diagram showing a plurality of screens of another electronic device according to some embodiments of the present disclosure.

FIG. 5 illustrates a schematic diagram showing a plurality of screens of another electronic device according to some embodiments of the present disclosure.

FIG. 6 illustrates a schematic flowchart of another audio output method according to some embodiments of the present disclosure.

FIG. 7 illustrates a schematic structural diagram of an audio output device according to some embodiments of the present disclosure.

FIG. 8 illustrates a schematic structural diagram of an electronic device according to some embodiments of the present disclosure.

### DETAILED DESCRIPTION OF THE EMBODIMENTS

To make the objectives, technical solutions, and advantages of embodiments of the present disclosure clearer, the technical solutions of embodiments of the present disclosure are described in detail below in connection with the accompanying drawings of embodiments of the present disclosure. Apparently, described embodiments are some embodiments of the present disclosure not all embodiments. Based on embodiments of the present disclosure, all other embodiments obtained by those skilled in the art without creative effort are within the scope of the present disclosure.

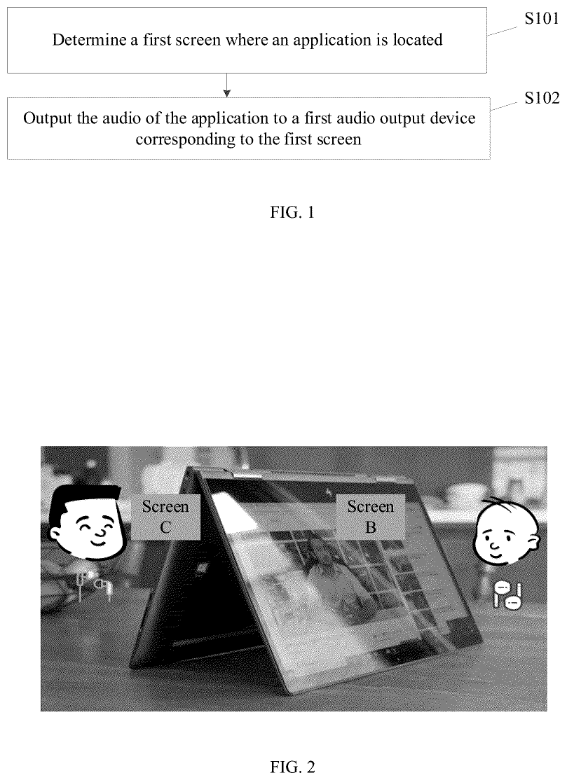

Embodiments of the present disclosure provide an audio output method, which is applied to an electronic device. As shown in FIG. 1, the audio output method includes the following processes.

At S101, a first screen where an application is located is determined.

In some embodiments, as shown in FIG. 2, the electronic device includes a plurality of screens. For example, the electronic device can be a dual-screen laptop or a dual-screen tablet. Shortcut launch icons of different applications can be displayed on different screens of the electronic device to facilitate a user to quickly find and launch a desired application. For example, if screen B is used for entertainment, and screen C is used for work, shortcut launch icons for entertainment-related applications can be displayed on screen B, and shortcut launch icons for office-related applications can be displayed on screen C. For another example, if screen B is for adults, and screen C is for children, screen B can display shortcut launch icons for office and entertainment applications, and screen C can display only shortcut launch icons for educational applications. After an application is launched, the first screen where the application is located may need to be determined in real-time. The first screen can be any one of the plurality of screens of the electronic device. For example, when a certain application is launched on screen B, screen B can be determined as the first screen where the application is located. After a certain application is launched on screen B, and the application window of the application is then transitioned to be displayed on screen C, screen C can be determined as the first screen where the application is located.

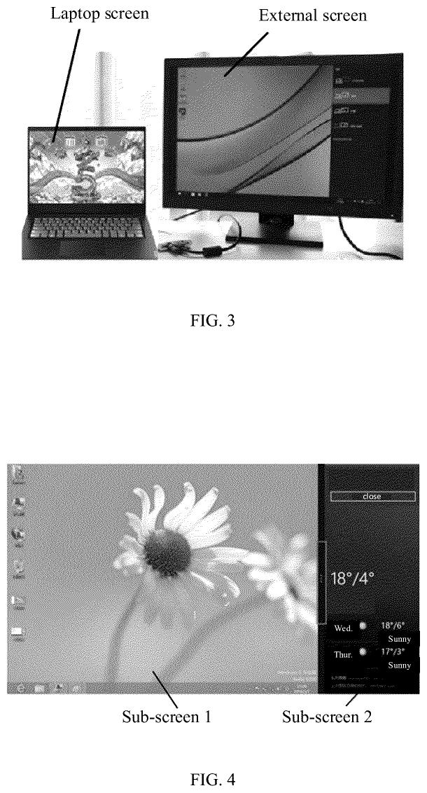

In some embodiments, as shown in FIG. 3, the electronic device is an electronic device with a single screen. The electronic device is connected to an external screen to form a multi-screen status. The screen of the electronic device and the external screen can display same or different contents. For example, the screen of the electronic device and the external screen can display different shortcut launch icons for different applications or a same shortcut launch icon for a same application. For another example, the screen of the electronic device and the external screen can display a same application window of the same application, different application windows of the same application, or different application windows of different applications. After a certain application is launched, if the application is only displayed on a screen, the screen displaying the application window of the application can be determined to be the first screen where the application is located. If the application is displayed on different screens, the plurality of screens can be determined to be the first screens where the application is located.

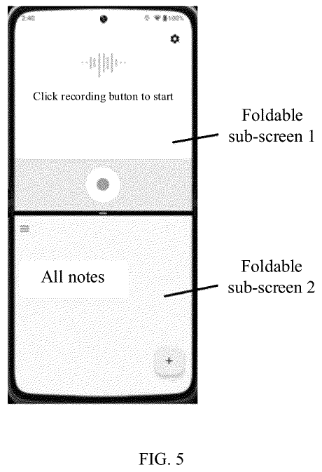

In some embodiments, as shown in FIG. 4, the electronic device is the electronic device with a single screen. The screen is divided into a plurality of sub-screens based on a screen division operation. Each sub-screen is a screen. Each screen can display a different content. For example, each screen can display an application window of different applications or a different window of a same application. When each screen displays the application windows of different applications, for an application of the different applications, the screen corresponding to the application window of the application can be determined as the first screen of the application. When each screen displays a different application window of the same application, each screen can be determined as the first screen where the application is located.

In some embodiments, as shown in FIG. 5, the electronic device is an electronic device with a foldable screen. The foldable screen is divided into a plurality of foldable sub-screens based on the folding operation. Each foldable sub-screen corresponds to a screen. Each screen can display a different content. For example, each screen can display an application window of different applications or a different window of a same application. When each screen displays the application windows of different applications, for an application of the different applications, the screen corresponding to the application window of the application can be determined as the first screen of the application. When each screen displays a different application window of the same application, each screen can be determined as the first screen where the application is located.

In some embodiments, when determining the first screen where the application is located, the screen where the application window of the application is located can be determined. Then, the screen where the application window is located can be determined as the first screen where the application is located.

In some embodiments, screenshots of display contents of the screens can be obtained. Recognition can be performed in the screenshots, or comparison can be performed on the screenshots and the application windows of the application to determine the application windows of the applications displayed on the screens. Then, the screen where the application window of the application is located can be determined and can be used as the first screen of the application. Thus, the first screen where the application is located can be quickly determined.

In some embodiments, since different screens have different interfaces when determining the first screen where the application is located, the first screen where the application is located can be searched based on interface information by obtaining the interface information of the operating system.

In some embodiments, the interface information of the operating system can be obtained to determine the interfaces of the operating system called by the application to accurately and quickly determine the first screen where the application is located.

At S102, the audio of the application is output to a first audio output device corresponding to the first screen.

In some embodiments, each screen can correspond to an audio output device. For example, when the electronic device with a plurality of screens, the first screen can correspond to the first audio output device, and a second screen can correspond to a second audio device. When the electronic device has only one screen, i.e., the first screen, the screen can correspond to the first audio output device. The external screen, i.e., the second screen, can correspond to the second audio output device. For the electronic device with a single screen that is divided into a plurality of screens based on the screen division operation, a first sub-screen, i.e., the first screen, can correspond to the first audio output device, and a second sub-screen, i.e., the second screen, can correspond to the second audio output device. For the electronic device with a foldable screen that is divided into a plurality of screens based on the folding operation, a first foldable screen, i.e., the first screen, can correspond to the first audio output device, and a second foldable screen, i.e., the second screen, can correspond to the second audio output device.

In some embodiments, the audio output device can include but is not limited to Bluetooth headphones, wired headphones, and speakers. For example, as shown in FIG. 2, screen B corresponds to a Bluetooth headphone, and screen C corresponds to a wired headphone.

In some embodiments, since each screen corresponds to an audio output device, and the first screen corresponds to the first audio output device after the first screen where the application is located is determined, the audio of the application can be directly output to the first audio output device corresponding to the first screen. That is, the audio of the application can be output to the audio output device corresponding to the screen where the application is displayed. In some embodiments, if the first screen where the application is located is a screen, the audio of the application can be output to the audio output device corresponding to the screen. If the first screen where the application is located is a plurality of screens, the audio of the application can be output to a plurality of audio output devices corresponding to the plurality of screens.

The audio output method of embodiments of the present disclosure can include outputting the audio of the application to the first audio output device corresponding to the first screen by determining the first screen where the application is located. Thus, the screen is associated with the audio output device, and the application is not associated with the audio output device. Therefore, when the first screen where the application is located is determined, the system can automatically modify the setting to allow the audio of the application to be output by the audio output device corresponding to the first screen. Thus, no matter the application is displayed on which screen, the audio of the application can be output by the audio output device corresponding to the screen. Thus, when the user changes the screen where the application is located, the user may not need to modify the setting of the audio output device of the application, and the audio output device of the application can be automatically changed, which improves the user experience.

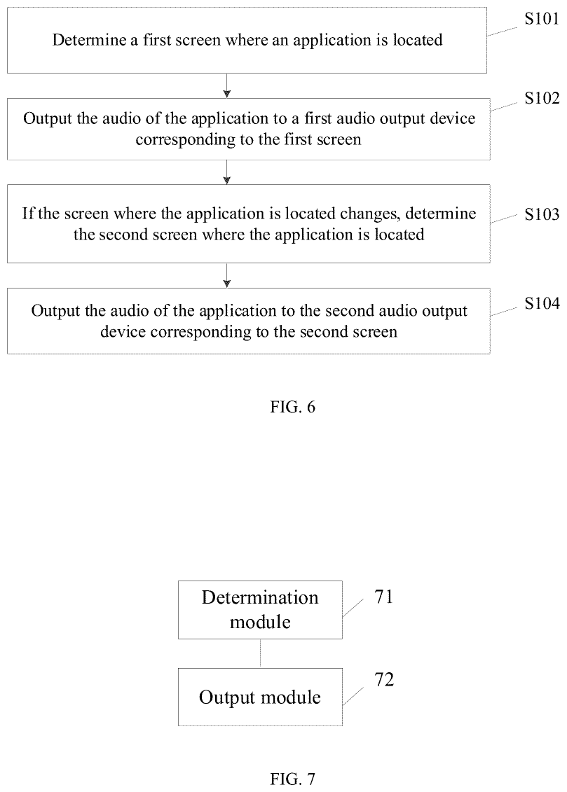

In some embodiments, as shown in FIG. 6, the audio output method further includes the following processes.

At S103, if the screen where the application is located changes, the second screen where the application is located is determined.

At S104, the audio of the application is output to the second audio output device corresponding to the second screen.

In step S103, during the use of the application, the screen where the application is located can be changed to meet the user needs. For example, the screen where the application window of the application is located can be switched to change the screen where the application is located. For example, the application displayed on the first screen can be switched to the second screen for display. In some other embodiments, some application windows of the application can be closed to change the screen where the application is located. For example, an application window of the application displayed on a screen can be closed while other application windows of the application displayed on other screens remain. When the screen where the application is located changes, the second screen where the application is located needs to be determined after determining that the screen is changed. The second screen can be a screen different from the first screen, a part of the first screen, or a combination of the first screen and other screens.

In some embodiments, the screen where the application is located being changed can include if a screen switch operation of the user for the application is detected, determining that the screen where the application is located is changed.

In some embodiments, whether the user input or trigger the screen switch operation of the application can be detected in real-time to determine whether the user performs the screen switch operation on the application. In some embodiments, the screen switch instruction of the application can be triggered through a shortcut or by selecting the screen switch key. The screen switch operation instruction of the application can be inputted through the shortcut or keyboard input. If the user is determined to input or trigger the screen switch operation instruction, the screen switch operation of the user for the application can be detected to determine that the screen where the application is located is changed.

In some embodiments, whether the screen where the application is located is changed can be determined by detecting whether the user performs the switch operation on the screen of the application. Thus, whether the user actively triggers the screen of the application to change can be determined in time, and a switched screen where the application is located can be determined in time, to output the audio of the application to the audio output device corresponding to the switched screen in time.

In some embodiments, the screen where the application is located being changed can include, if detecting the plurality of application windows of the application are changed, determining that the screen where the application is located is changed.

In some embodiments, the plurality of application windows of the application can be displayed on different screens. When the plurality of application windows of the application is detected to be changed, e.g., some application windows are closed, or some other application windows are opened, the screen where the application is located can be determined to be changed.

In some embodiments, by detecting whether the plurality application windows of the application are changed, the screen where the application is located can be determined. Thus, when the application window of the application is closed or a new application window is increased, the screen corresponding to the closed application window or the screen corresponding to the added application window can be determined in time to adjust the audio output device corresponding to the application.

In some embodiments, the first screen and the second screen can belong to different display areas of the same display screen or different screens.

In some embodiments, based on the description of the plurality of screens of the electronic device, if the first screen and the second screen are obtained based on the screen division or by performing the folding operation on the foldable screen, the first screen and the second screen can belong to different display areas of the same screen. When the electronic device has a plurality of screens or is connected to the external screen to obtain the plurality of screens, the first screen and the second screen can belong to different screens.

In some embodiments, the screen can be a flexible screen that can be foldable.

In some embodiments, by setting the first screen and the second screen to belong to different display areas of the same screen or different screens, when the screen can be divided into a plurality of screens, folded to obtain the plurality of screens, or connected to the external screen to obtain the plurality of screens, or the electronic device has the plurality of screens, the audio corresponding to the application displayed on the different screens can be output to the audio output devices corresponding to the screens. That is, no matter which screen displays the application, the audio can be output by the audio output device corresponding to the screen. Therefore, when the user changes the screen where the application is located, the user may not need to set the audio output device of the application again, and the audio output device of the application can be automatically switched, which improves the user experience.

In step S104, after the second screen where the application is located is determined, since the second screen is associated with the second audio device, the audio corresponding to the application can be output through the second audio output device associated with the second screen.

In some embodiments, if the second screen is different from the first screen, the audio of the application can be output by the second audio output device associated with the second screen. If the second screen is a part of the first screen, the audio of the application can be output by the audio output device associated with the part of the screen. If the second screen is a combination of the first screen and other screens, the audio of the application can be output by the first audio output device associated with the first screen and the audio output devices associated with the other screens.

In some embodiments, when the screen where the application is located is changed, and the audio of the application is output to the audio output device corresponding to the changed screen, the audio output device of the application can be automatically changed when the screen corresponding to the application is changed. The user may not need to set the audio output device of the application. Thus, the user experience can be improved.

In some embodiments, if the application includes a plurality application windows, determining the first screen where the application is located, and outputting the audio of the application to the first audio output device corresponding to the first screen can include determining the first screen where each application window is located for each application window and outputting the audio corresponding to each application window to the first audio output device of the corresponding first screen.

In some embodiments, for an application, the plurality of application windows can be opened. The plurality of application windows can play a same audio content or different audio contents. If the plurality of application windows plays different audio contents, an audio corresponding to each application window needs to be obtained. If the plurality of application windows play the same audio content, the audio corresponding to the application window can be obtained. Thus, the audio corresponding to each application window can be determined. If the plurality of application windows are displayed on different screens, the first screen where each application window is located needs to be determined. Then, the audio of each application window can be output to the corresponding first audio output device of the first screen.

In some embodiments, if the application includes a plurality of application windows, for each application window, the first screen where each application window is located can be determined. The audio corresponding to each application window can be output to the first audio output device of the corresponding first screen. Thus, the first audio corresponding to each application window of the application can be output to the first audio output device corresponding to the screen displaying the application window. The audios of different application windows of the same application can be output by different audio output devices.

In some embodiments, in step S101, before determining the first screen where the application is located, the audio output method further includes obtaining the plurality of screens of the electronic device, obtaining the plurality of audio output devices, and associating the plurality of screens to the plurality of audio output devices in a one-to-one correspondence.

In some embodiments, by associating the plurality of screens to the plurality of audio output devices in the one-to-one correspondence, each screen can correspond to one audio output device. Thus, when different users use different screens, each user can use the audio output device corresponding to the screen of the user.

In some embodiments, the audio output method is further described below.

As shown in FIG. 2, the user pairs screen B with Bluetooth headphones and pairs screen C with wired headphones using software. For example, user 1 can use screen B to watch a series through the Bluetooth headphones, and user 2 can use the wired headphones to listen to music and browsing websites on screen C. Then, user 1 wants to share a watched segment with user 2, user 1 just needs to move the application window to screen C, and the user 2 can watch the video shared by user 1 on screen C without changing to the Bluetooth headphones and modifying the audio output device in the system. User 2 can also hear the sound in his headphones.

As shown in FIG. 7, embodiments of the present disclosure provide an audio output device. The audio output device includes a determination module 71 and an output module 72.

The determination module 71 can be configured to determine the first screen where the application is located.

The output module 72 can be configured to output the audio of the application to the first audio output device corresponding to the first screen.

With the audio output device of embodiments of the present disclosure, by determining the first screen where the application is located, the audio of the application can be output to the first audio output device corresponding to the first screen. Thus, the screen can be associated with the audio output device, and the application is not associated with the audio output device. Thus, as long as the first screen where the application is located is determined, the system can automatically modify to output the audio by the audio output device corresponding to the first screen. Thus, no matter on which screen the application runs, the audio of the application can be output by the audio output device corresponding to the screen. Thus, when the user modifies the screen where the application is located, the user may not need to set the audio output device of the application, and the audio output device of the application can be automatically switched. Thus, the user experience can be improved.

In some embodiments, the determination module can be configured to obtain interface information of the operating system and search for the first screen where the application is located based on the interface information.

In some embodiments, the audio output device further includes a modification module 73 configured to, if the screen where the application is located is changed, determine the second screen where the application is located and output the audio of the application to the second audio output device corresponding to the second screen.

In some embodiments, the modification module 73 can be configured to, if the screen switch operation of the user for the application is detected, determine that the screen where the application is located is changed.

In some embodiments, if the application includes a plurality of application windows, the determination module 71 can be configured to, for each application window, determine the first screen where each application window is located, and the output module 72 can be configured to output the audio corresponding to each application window to the first audio output device of the corresponding first screen.

In some embodiments, before the determination module 71, the audio output device further includes an acquisition module 70 configured to obtain the plurality of screens of the electronic device, obtain the plurality of audio output devices, and associate the plurality of screens with the plurality of audio output devices in a one-to-one correspondence.

In some embodiments, the first screen and the second screen can belong to different display areas of the same screen or different screens.

In some embodiments, the screen can be a foldable flexible screen.

According to embodiments of the present disclosure, the present disclosure further provides an electronic device and a readable storage medium.

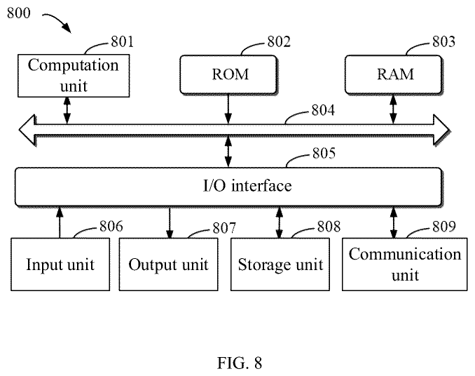

FIG. 8 illustrates a schematic structural diagram of an electronic device 800 according to some embodiments of the present disclosure. The electronic device can be various forms of digital computers, such as laptops, desktop computers, workstations, personal digital assistants, servers, blade servers, mainframes, and other suitable computers. The electronic device can also be various forms of mobile devices, such as personal digital assistants, cell phones, smartphones, wearable devices, and other similar computation devices. Members, connections and relationships of the members, and functions of the members shown here are exemplary and are not intended to limit the present disclosure described and/or required here.

As shown in FIG. 8, the device 800 includes a computation unit 801. The computation unit 801 can be configured to perform various suitable actions and processes according to the computer program stored in a read-only memory (ROM) 802 or the computer program loaded to a random access memory (RAM) 803 from a storage unit 808. In RAM 803, various programs and data required for the operation of the storage device 800 can be stored. The computation unit 801, the ROM 802, and the RAM 803 are connected to each other through a bus 804. An input/output (I/O) interface 805 is also connected to the bus 804.

A plurality of members in the device 800 are connected to the I/O interface 805 and include an input unit 806, e.g., a keyboard and a mouse, an output unit 807, e.g., various screens and speakers, a storage unit 808, e.g., magnet discs and optical discs, and a communication unit 809, e.g., a network card, a modem, and a wireless communication transceiver. With the communication unit 809, the device 800 can exchange information/data with other devices through a computer network, such as the Internet, and/or various communication networks.

The computation unit 801 can be general and/or special-purpose processing assemblies having processing and computation capabilities. The computation unit 801 can include but is not limited to a central processing unit (CPU), a graphics processing unit (GPU), various specialized artificial intelligence (AI) computing chips, various computing units running machine learning model algorithms, a digital signal processor (DSP), and any suitable processors, controllers, and microcontrollers. The computation unit 801 can be configured to perform the methods and processes above, such as the audio output method. For example, in some embodiments, the audio output method can be implemented as a computer software program, which is tangibly included in a computer-readable medium, e.g., the storage unit 808. In some embodiments, a part or all of the computer program can be loaded and/or installed on the device 800 through the ROM 802 and/or the communication unit 809. When the computer program is loaded into the RAM 803 and executed by the computation unit 801, one or more steps of the audio output method above can be performed. In some other embodiments, the computation unit 801 can be configured to perform the audio output method in any suitable method (e.g., through firmware).

System and technology embodiments above can be implemented in digital electronic circuit systems, integrated circuit systems, field-programmable gate arrays (FPGAs), application-specific integrated circuits (ASICs), application-specific standard products (ASSPs), system-on-chip (SOC) devices, complex programmable logic devices (CPLDs), computer hardware, firmware, software, and/or a combination thereof. Embodiments of the present disclosure can be implemented in one or more computer programs. The one or more computer programs can be implemented and/or explained in a programmable system including at least one programmable processor. The programmable processor can be a special purpose or general-purpose programmable processor, which can receive data and instructions from the storage system, at least one input device, and at least one output device and transmit the data and the instructions to the storage system, the at least one input device, and the at least one output device.

Program codes used to implement the method of embodiments of the present disclosure can be written in any combination of one or more programing languages. The program codes can be provided to a general-purpose computer, a special-purpose computer, or a processor or controller of another programmable data processing device. Thus, when the program codes are executed by the processor or controller, the functions/operations defined in the flowchart and/or block diagram can be performed. The program codes can be executed fully or partially on the machine. The program codes can also be used as an independent software packet, which can be partially performed on the machine and partially performed by a remote machine or fully performed by the remote machine or server.

In embodiments of the present disclosure, the machine-readable medium can be a physical medium including or storing the program for the instruction execution system, device, or apparatus to use or used in connection with the instruction execution system, device, or apparatus. The machine-readable medium can be a machine-readable signal medium or a machine-readable storage medium. The machine-readable medium can include but is not limited to electronic, magnetic, optical, electromagnetic, infrared, or semiconductor systems, devices, or apparatuses, or a combination thereof. In some embodiments, the machine-readable storage medium can include an electrical connection based on one or more wires, a portable computer disk, a hard drive, a random access memory, a read-only memory, an erasable and programmable ROM (EPROM), optical fibers, a compact disk read-only memory (CD-ROM), an optical storage device, a magnetic storage device, or a combination thereof.

To enable user interaction, the system and technology can be implemented on a computer. The computer includes a display device (e.g., a CRT or LCD monitor) configured to display information to the user, a keyboard, and a pointing device (e.g., a mouse or a trackball). The user can provide an input to the computer through the keyboard and the pointing device. Another type of device can also be configured to provide user interaction. For example, the feedback provided to the user can be any type of sensory feedback (e.g., visual, auditory, or tactile feedback). The input of the user can be received in any form (e.g., sound input, audio input, and tactile input).

The system and technology can be implemented in a computer system including a backend member (e.g., as a data server), a computer system including a middleware member (e.g., as an application server), or a computer system including a frontend member (e.g., a user computer with a graphical user interface or web browser through which the user can interact with the implementations of the system and technology), or a computer system including any combination of the backend member, the middleware member, or the frontend member. The members of the system can be interconnected through digital data communication via any form or medium (e.g., a communication network). The communication network can include a local area network (LAN), a wide area network (WAN), and the internet.

A computer system can include a client and a server. The client and the server are generally remote from each other and typically interact via a communication network. The client-server relationship can be generated by running a computer program having a client-server relationship on a corresponding computer. The server can be a cloud server, a server of a distributed system, or a server combined with blockchain.

Steps can be resorted, added, or deleted using the processes shown above. For example, the steps of embodiments of the present disclosure can be performed in parallel, in sequence, or in a different order, as long as the expected result of the technical solution of the present disclosure can be achieved, which is not limited here.

In addition, the terms “first” and “second” are used solely for descriptive purposes and should not be construed as indicating or implying relative importance or indicating the quantity of the indicated technical features. Therefore, features designated with “first” or “second” can explicitly or implicitly include at least one of the features. In the description of the present disclosure, the term “a plurality of” means two or more, unless specifically and distinctly otherwise specified.

The above are only some embodiments of the present disclosure. However, the scope of the present disclosure is not limited here. Those skilled in the art can easily think of modifications or replacements within the scope of the present disclosure. These modifications or replacements are within the scope of the present disclosure. Thus, the scope of the present disclosure is subject to the scope of the claims.

What is claimed is:

1. An audio output method, comprising:
determining a first screen where an application is located; and
outputting an audio of the application to a first audio output device corresponding to the first screen.

2. The method according to claim 1, wherein determining the first screen where the application is located includes:
obtaining interface information of an operating system; and
searching for the first screen where the application is located based on the interface information.

3. The method according to claim 1, further comprising:
in response to a screen where the application is located being changed, determining a second screen where the application is located; and
outputting the audio of the application to a second audio output device corresponding to the second screen.

4. The method according to claim 3, wherein the screen where the application is located being changed includes:
in response to detecting a screen switch operation of a user on the application, determining that the screen where the application is located is changed.

5. The method according to claim 3, wherein the first screen and the second screen belong to different display areas of a same screen or different screens.

6. The method according to claim 5, wherein the screen is a foldable and flexible screen.

7. The method according to claim 1, wherein if the application includes a plurality of application windows, determining the first screen where the application is located and outputting the audio of the application to the first audio output device corresponding to the first screen includes:
for each application window, determining the first screen where the application window is located; and
outputting the audio corresponding to the application window to the first audio output device corresponding to the first screen.

8. The method according to claim 1, further comprising, before determining the first screen where the application is located:
obtaining a plurality of screens of the electronic device;
obtaining a plurality of audio output devices; and
associating the plurality of screens with the plurality of audio output devices in a one-to-one correspondence.

9. An audio output device, comprising:
a determination model configured to determine a first screen where an application is located; and
an output module configured to output an audio of the application to a first audio output device corresponding to the first screen.

10. The device according to claim 9, wherein the determination module is further configured to:
obtain interface information of an operating system; and
search for the first screen where the application is located based on the interface information.

11. The device according to claim 9, wherein:
the determination module is further configured to, in response to a screen where the application is located being changed, determine a second screen where the application is located; and
the output module is further configured to output the audio of the application to a second audio output device corresponding to the second screen.

12. The device according to claim 11, wherein the determination module is further configured to:
in response to detecting a screen switch operation of a user on the application, determine that the screen where the application is located is changed.

13. An electronic device, comprising:
a processor; and
a memory communicatively connected to the processor and storing executable instructions that, when executed by the processor, cause the processor to:
determine a first screen where an application is located; and
output an audio of the application to a first audio output device corresponding to the first screen.

14. The device according to claim 13, wherein the processor is further configured to:
obtaining interface information of an operating system; and
searching for the first screen where the application is located based on the interface information.

15. The device according to claim 13, wherein the processor is further configured to:
in response to a screen where the application is located being changed, determine a second screen where the application is located; and
output the audio of the application to a second audio output device corresponding to the second screen.

16. The device according to claim 15, wherein the processor is further configured to:
in response to detecting a screen switch operation of a user on the application, determine that the screen where the application is located is changed.

17. The device according to claim 15, wherein the first screen and the second screen belong to different display areas of a same screen or different screens.

18. The device according to claim 17, wherein the screen is a foldable and flexible screen.

19. The device according to claim 13, wherein if the application includes a plurality of application windows, the processor is further configured to:
for each application window, determine the first screen where the application window is located; and
output the audio corresponding to the application window to the first audio output device corresponding to the first screen.

20. The device according to claim 13, wherein the processor is further configured to:
obtain a plurality of screens of the electronic device;
obtain a plurality of audio output devices; and
associate the plurality of screens with the plurality of audio output devices in a one-to-one correspondence.
